(19) United States
(12) Patent Application Publication
(10) Pub. No.: US 2026/0258857 A1
(43) Pub. Date: Sep. 3, 2026

(54) IMPROVED FILTERING PULLEY

(71) Applicant: MUVIQ S.R.L., Ivrea (IT)

(72) Inventors: Christopher R. BUDDINGTON, Livonia, MI (US); Andrea GUALA, Ivrea (IT); Stefano AMADIO, Ivrea (IT); Michael MCGAHEY, Troy, MI (US); Bruce CHRISTENSON, Canton, MI (US)

(73) Assignee: MUVIQ S.R.L., Ivrea, TO (IT)

(21) Appl. No.: 19/474,415

(22) PCT Filed: Feb. 5, 2024
(86) PCT No.: PCT/IB2024/051040

§ 371 Date: Oct. 10, 2025

(30) Foreign Application Priority Data
Apr. 13, 2023 (IT) 102023000007116

(51) Int. Cl. F16H 55/36; F16F 15/121

(52) U.S. Cl. CPC F16H 55/36; F16F 15/121; F16H 2055/366

(57) ABSTRACT

Filtering pulley has a hub adapted to be fixed to a shaft rotating around an axis (A), a crown mounted coaxially and rotationally free on the hub via a bearing, at least one elastic group arranged circumferentially with respect to the hub and the crown and interposed, each, between a pair of first elements fixedly carried by the hub and between a pair of second elements fixedly carried by the crown. The hub has an actuator carrier portion and a crankshaft engaging portion connected by a fixing member. The actuator carrier portion and the crankshaft engaging portion have different mechanical properties with respect to each other.

### CROSS-REFERENCE TO RELATED APPLICATIONS

This Patent Application claims priority from Italian Patent Application No. 102023000007116 filed on Apr. 13, 2023, the entire disclosure of which is incorporated herein by reference.

### TECHNICAL FIELD OF THE INVENTION

The present invention relates to a filtering pulley, preferably a pulley for a crankshaft in an accessory drive of an internal combustion engine.

### STATE OF THE ART

As is known, the drive shaft in internal combustion engines is subjected to torsional vibrations due to the periodic stress caused by the combustion in the cylinders. Such vibrations are particularly intense at the start and at low speeds, as well as in the presence of particular constructional solutions such as, for example, the use of double clutch gearboxes or start-stop systems.

The torsional vibrations result in rotational irregularities of the drive pulley of the accessory drive which are transmitted to the accessories by means of the drive belt, which is thus subjected to periodic tension variations.

With the object “to filter” the torsional oscillations transmitted from the crankshaft to the belt, a filtering pulley is generally used as drive pulley, said filtering pulley being provided with a hub integral with the drive Shaft, a crown cooperating with the belt and one or more elastic elements through which the torque is transmitted from the hub to the crown. The filtering pulley may be also provided with damper means. An example of such filtering pulley is illustrated in WO2022/243857 A1.

However, in case of filtering pulley provided with damper means, different problems arise.

Indeed, there is need of a precise coupling between the damper and the pulley on the crankshaft. Indeed, the damper means are usually provided with an unbalance mass that is designed to compensate the inertia of the crankshaft.

However, in known decouplers, the fixation of the damper means to the pulley is complicated and time consuming.

Moreover, the hub needs to support a heavy load. In particular, in the portion of the hub provided with bearings or bushings the load could be so high that performing materials such as high-performance steels could be used, thereby increasing manufacturing costs.

Moreover, since there is the presence of both a filtering pulley and a damper, a great damping mass is needed in order to provide an effective damping to the system., a great damping mass is needed in order to provide an effective damping. Clearly such mass value increases the weight of the decoupler assembly thereby reducing the manoeuvrability of the decoupler assembly and increasing its manufacturing costs.

Furthermore, the sealing means provided to known decouplers are usually housed in seats that needs to be machined on the hub thereby increasing the manufacturing costs of the decoupler.

In view of the above there is need to provide a filtering pulley that solves the aforementioned drawbacks with respect to the existing decouplers and that is realized in a cost-effective and optimized manner.

### SUBJECT AND SUMMARY OF THE INVENTION

The aforementioned object is achieved by a filtering pulley assembly according to what claimed in the appended claims.

### BRIEF DESCRIPTION OF THE DRAWINGS

In order to better understand the present invention, a preferred embodiment is described in the following, by way of non-limiting example and with reference to the accompanying drawings, wherein:

FIG. 1 is a perspective view of a pulley according to the invention;

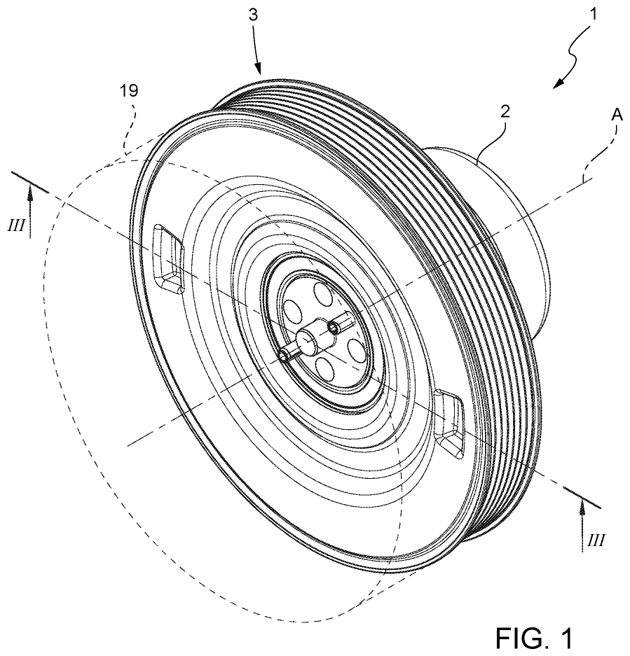

FIG. 2 is a perspective exploded view of the pulley of FIG. 1;

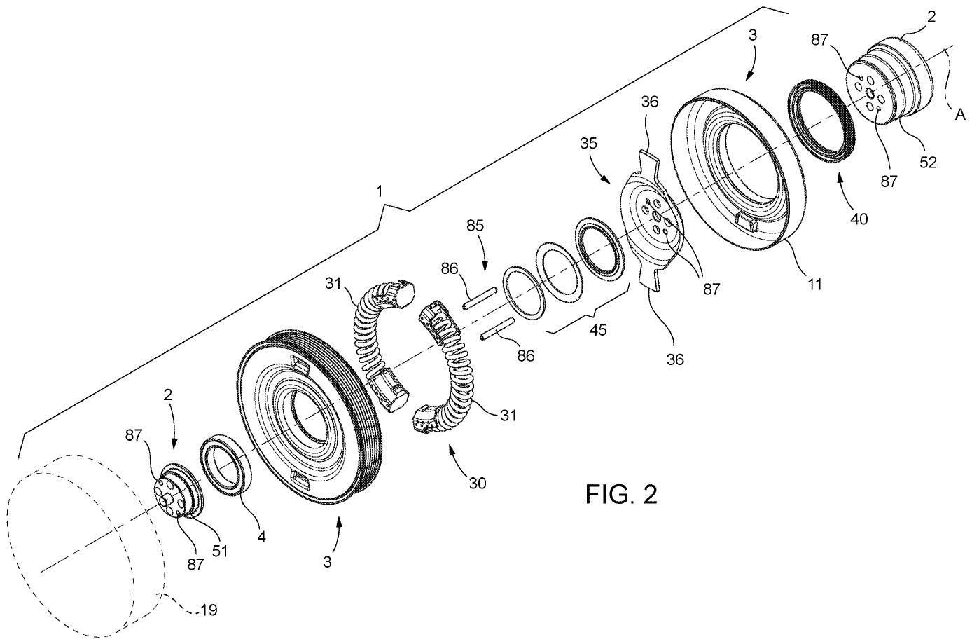

FIG. 3 is a sectional diametral view of the pulley of FIG. 1; and

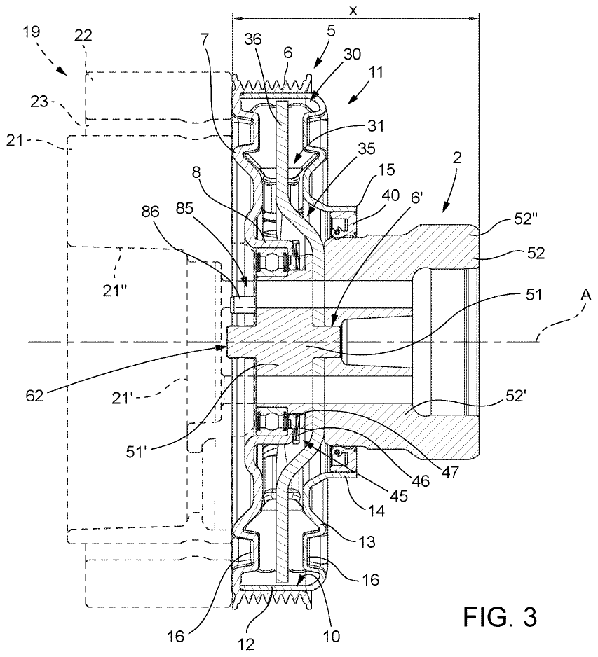

FIG. 4 is an exploded view of the sectional diametral view of FIG. 3.

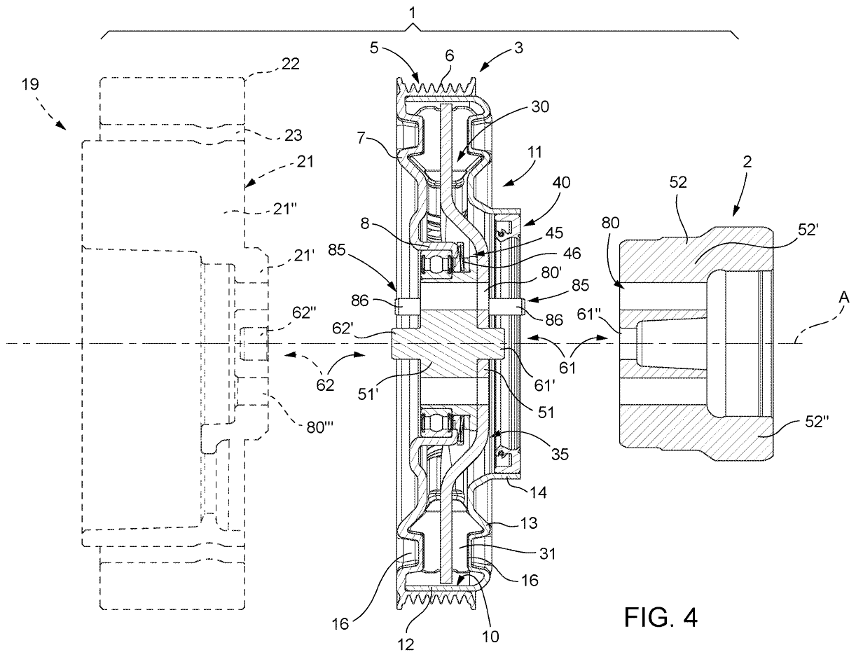

### DETAILED DESCRIPTION OF PREFERRED EMBODIMENTS OF THE INVENTION

In the accompanying figures, a filtering pulley assembly 1 is represented comprising a hub 2 of axis A, adapted to be connected to a shaft (not represented), for example a crankshaft of an internal combustion engine, and an annular crown 3 externally coaxial to the hub 2 and supported in a rotationally free manner on the hub 2 by means supporting means 4.

The crown 3 comprises an annular portion 5 provided with a profile 6 adapted to cooperate with a poly-V belt (not represented). The crown 3 further comprises a radial wall 7, integral with the annular portion 5 and preferably of a single piece therewith, extending radially towards the hub 2 from the annular portion 5, and a substantially cylindrical internal wall 8 of axis A extending from a terminal portion of the radial wall 7 opposite to the annular portion 5.

Preferably, internal wall 8 cooperates with supporting means 4 that in the disclosed embodiment are represented one bearing.

The crown 3 carries, integral thereto, a closing element 11 configured to cooperate with the crown 3 to delimit a space 10. In particular the closing element 11 comprises an outer cylindrical wall 12 of axis A, a radial annular wall 13 extending radially from an axial terminal portion of the cylindrical wall 12 opposite to wall 7 and a terminal wall 14 extending axially of axis A from a terminal portion of the radial annular wall 13 opposite to the cylindrical wall 12.

The closing element 11 is driven into the crown 3 so as to form the aforementioned space 10 that is in particular an annular space radially comprised between the wall 12 and the wall 8 and axially delimited by the wall 7 and the wall 13.

In particular the wall 13 extends radially less than walls 13 therefore providing an annular clearance 15 between the wall 8 and the hub 2.

At least one between the crown 3 and the closing element 11 comprises two diametrically opposite projections 16 axially extending inside the space 10 starting from the faced wall 7 and 13. The projections 16 divide the space 10 into two portions preferably of equal dimensions.

The aforementioned projections 16 are carried fixed by the respective walls or, alternatively, made of a single piece with the same. In the disclosed embodiment, the projections 16 are realized as protuberances integrally realized in both walls 7 and 13.

The pulley assembly 1 can further be provided with a damper 19, such as a torsional vibration damper, comprising hub portion 21 fixedly carried by hub 2, a seismic ring 22 carried by the hub portion 21 and a deformable ring 23 operationally interposed between the hub portion 21 and the seismic ring 22; in particular the deformable ring 23 is made of elastomeric material.

In particular, the hub portion 21 comprises a coupling portion 21′ configured to be fixedly carried by the hub 2 and a disc portion 21″ extending from the coupling portion 21″ opposite to the hub 2.

As is illustrated, the pulley 1 further comprises at least one elastic group 30, for example two elastic groups 30 arched and arranged circumferentially free in the respective portions of the chamber 10 delimited by the projections 16.

Each of the elastic groups 30 comprises at least one spring, in the described embodiment a helical and arched spring 31 mounted between the aforementioned projections 16.

The pulley 1 further comprises an actuator 35 fixedly carried by the hub 2. The actuator 35 has two spokes 36 free to move circumferentially in the space 10 and adapted to interact with the elastic groups 30 by contact as described in the following.

The actuator 35 can be placed in contact with the elastic groups 30, possibly with a circumferential interference value so as to preload the elastic groups 30 inside the space 10 or, alternatively, it can be placed with an angular play with respect to the elastic groups 30, i.e. an angular clearance before entering into contact with these latter.

The pulley 1 can also further comprise sealing means 40, in particular dust protection means 40 configured to configured to isolate the space 10 from the outside.

In particular, the dust protection means 40 are configured as a dust protection lip, such as a labyrinthic seal, placed radially in annular clearance 15, in particular between closing element 11, namely the inner wall 14, and the hub 2. Accordingly, the dust protection means 40 isolates space 10 from the environment.

In particular, dust protection means 40 are fixedly carried by the closing element 11 and slides over the outer surface of hub 2.

The dust protection means 40 are preferably realized as one piece in polymeric material.

Preferably, the pulley 1 further comprises sealing means 45, placed axially between hub 2 and crown 3, in particular between the inner wall 8 of crown 8 and hub 2. Accordingly, the sealing means 45 isolates space 10 from support means 4.

Advantageously, the second protection means 45 comprises an elastic element 46 configured to give an axial compression force along the axis A and a sealing element 47 configured to be placed in contact with the wall 8.

Advantageously, the hub 2 comprises a plurality of elements 51, 52 connected together via respective shape coupling.

In particular, a first element 51 carries the actuator 35 and a second element 52 is configured to be fixed to the crankshaft of the engine.

The second element 52 comprises a main element 52′ that is substantially cylindrical and a coupling element 52″ extending axially from the main element 52′ and configured to allow coupling with the crankshaft. In the disclosed embodiments the coupling element 52″ is substantially annular, however, it is clear that any shape can be provided according to the needed shape for coupling with the crankshaft.

It is noticed that the main element 52′ inner radially delimit the annular clearance 15 and therefore supports the first protection means 40′.

The first element 51 comprises a main portion 51′ that is substantially cylindrical. Such main portion 51″ furthermore carries the aforementioned spokes 36 of the actuator 35.

In further detail, the spokes 36 are carried by frictional contact between the main portions 51′, 52′ of the first and second elements 51, 52.

In particular, the first element 51 is realized in a different material with respect to the second element 52. In particular, both elements 51, 52 are realized in metallic material such as steel with different mechanical properties.

Preferably, the metallic composition of the elements 51, 52 may be substantially the same and the first and second elements 51, 52 can be subjected to different thermal and/or chemical and/or electro-chemical surface treatment in order to provide the aforementioned different mechanical properties to at least the surface of the elements 51, 52.

In greater detail, the first element 51 has a greater hardness with respect to the second element 52. In detail, the first element 51 has a hardness that is greater than 20 HRC, i.e. Rockwell hardness scale, more preferably comprises between 20 and 30 HRC.

As said, the first and the second elements 51, 52 are mechanically coupled by a shape coupling 61. Preferably such shape coupling 61 comprises a protrusion 61′ carried in a fixed manner to one between the first and the second elements 51, 52 and a seat 61″ realized in the other between the first and the second elements 51, 52; such protrusion 61′ is configured to be housed within seat 61″. In particular, the protrusion 61′ is seated in seat 61″ with a pre-set interference.

Advantageously, the protrusion 61′ is realized as a cylindrical plug configured to be housed in a cylindrical seat 61″. In the disclosed embodiment, the protrusion 61′ is realized on the first element 51 and the seat 61″ is realized in the second element 52.

The protrusion 61′ and the seat 61″ are advantageously parallel and more preferably concentric to axis A.

Advantageously, the first element 51 is connected to the hub portion 21 of the damper 19 via a shape coupling 62. Preferably such shape coupling 62 comprises a protrusion 62′ carried in a fixed manner to one between the first element 51 and the hub portion 21 and a seat 62″ realized in the other between the first element 51 and the hub portion 21; such protrusion 62′ is configured to be housed within the seat 62″. In particular, the protrusion 62′ is seated in seat 62″ with a pre-set interference.

Advantageously, the protrusion 62′ is realized as a cylindrical plug configured to be housed in a cylindrical seat 62′'. In the disclosed embodiment, the protrusion 62′ is realized on the first element 51 and the seat 62″ is realized in the hub portion 21.

The protrusion 62′ and the seat 62″ are advantageously parallel and more preferably concentric to axis A, therefore being concentric to the protrusion and seat 61′, 61′ of the shape coupling 61 between first and second elements 51, 52 of hub 2. In particular, such shape couplings 61, 62 have the same shape and dimensions.

In addition to the above a shape couplings 61, 62, elements 51, 52 and the hub portion 21 of the damper 19 are connected together via fixing means (not shown) such as threaded connection, e.g. bolts.

Accordingly, pulley 1 comprises axial openings 80 configured to allow the insertion and coupling of such fixing means. Preferably such axial openings 80 are at least four openings placed circumferentially spaced about axis A, more preferably equally spaced one with respect to the other.

In particular, the first element 51 comprises a first section 80′ of such axial openings 80, the second element 52 comprises a second section 80″ of such axial openings 80 and the hub portions 21 comprises a third section 80′″ of such axial openings 80.

The decoupler assembly 1 further comprises centring means 85 configured to allow mounting of the different elements carried by the hub 2, i.e. the actuator 35 and, if present, the damper 19 in a predefined angular position with respect to the hub 2 and, therefore, to the crankshaft of the vehicle.

In particular, centring means 85 comprises pins 86 fixedly carried by one of the portions of the hub 51, 52 and configured to be housed within respective openings 87 realized in the actuator 35, in the other of the portions of the hub 51, 52 and, if present, of the damper 19.

In the disclosed embodiment pins 86 are two and are spaced circumferentially about axis A in two angular opposite position. The openings 87 are realized on the actuator 35 and damper 19 in precise positions in order to allow the mounting of the actuator 35 and damper 19 in a circumferential predefined position about axis A.

It is furthermore noticed that the damper 19, when present, is placed at a pre-set distance X with respect to the crankshaft coupling, i.e. to the extremity of the hub 2 opposite with respect to the damper 19.

In detail, such present distance X is greater than 80 mm, preferably greater than 100 mm and in particular 120 mm. In particular, the mass of the damper 19 at such present distance X is comprises in a range between 7 and 11 kg. More in detail, the inertial mass is 82 kgmm.

The operation of the pulley 1 according to the above two described embodiments follows.

During the standard operation of the pulley 1, in a first operational step, usually called driving mode and constituting the normal operation of the pulley 1, when the drive shaft pulls the accessories, the speed of the hub 2 tends to exceed the speed of the crown 3. For this reason, the spokes 36 of the actuator 35 transmit the torque to the projections 16 with the interposition of the respective elastic groups 30.

What described above occurs, symmetrically, in the overrunning condition, i.e. when the speed of the crown 3 tends to exceed the speed of the hub 2.

The advantages of a pulley 1 according to the invention are thus evident.

Thanks to the presence of centring means the actuator 35 and the damper 19 can be coupled to the hub in a specific circumferential position thereby optimizing the damping properties of the decoupler.

Moreover, the mounting of the decoupler is overall improved via the presence of the hub realized in different parts coupled together via shape couplings and via centring means.

Furthermore, since the sealing means 40 are not carried in a seat realized in the hub but slides on this latter and are carried by the crown, the manufacturing of the decoupler is economic since no dedicated seats or complicating mounting are necessary.

Moreover, thanks to the fact that the first portion of the hub is realized in a different, harder, material/surface treatment, this latter can support the heavy loads without need of realizing entirely the hub with such material/surface treatment. This provided costs savings while maintaining good performances.

Furthermore, thanks to the peculiar distance of the damper with respect to the crankshaft coupling, it is possible to reduce its mass, thereby leading to cost savings in manufacturing the decoupler and in less weight, thereby facilitating its mounting.

All the above effects are achieved while maintaining good filtering properties of the decoupler.

Furthermore, synergically, all elements contribute to make the overall manufacturing of the pulley simplified and economic.

Finally, it is clear that modifications or variations can be made to the described pulley which do not depart from the scope of protection defined by the claims.

First of all, the pulley could be used not exclusively on the crankshaft of an internal combustion engine but for one of the accessories of the same.

With reference to the elastic group 30, they could be realized in many different manners without anyway modifying their function. For example, they could comprise springs of different nature or several springs, in series or in parallel. Still, the elastic groups could be four and likewise the spokes of the actuator.

The dynamic damper could be absent and the actuator could be carried differently by the hub. Likewise, the roller bearings can be replaced by a bush.

Still, the disclosed sealings could be replaced by devices having the same function.

1. Filtering pulley comprising:
a hub adapted to be fixed to a shaft rotating around an axis (A),
a crown mounted coaxially and rotationally free on said hub via support means,
at least one elastic group arranged circumferentially with respect to said hub and said crown and interposed, each, between a pair of first elements fixedly carried by said hub and between a pair of second elements fixedly carried by said crown,
wherein said hub comprises a first portion and a second portion connected together by fixing means, wherein at least one of the first portion or the second portion thereof cooperates with said support means and one of said first portion and said second portion has a greater hardness with respect to said other.

2. The filtering pulley according to claim 1, wherein said first portion and said second portion comprise different materials, thereby providing one with the greater hardness.

3. The filtering pulley according to claim 1, wherein said first portion and said second portion are are treated by at least one different thermal, chemical, electro-chemical surface treatment.

4. The filtering pulley according to claim 1, wherein said greater hardness is at least 20 HRC.

5. The filtering pulley according to claim 1, wherein said second portion is configured to be connected to said shaft, said first elements being carried between said first and second portions of said hub or fixedly carried by one of said first and second portions.

6. The filtering pulley according to claim 5, wherein said first portion and said second portion are connected by a shape coupling.

7. The filtering pulley according to claim 6, wherein the shape coupling comprises a protrusion carried in a fixed manner to one of said first portion and said second portion and a seat realized in the other thereof.

8. The filtering pulley according to claim 1, further comprising a dynamic damper, wherein said dynamic damper comprises a hub portion carried by said first portion of said hub via a shape coupling

9. The filtering pulley according to claim 8, wherein the shape coupling comprises a protrusion carried in a fixed manner to one of said first element and said hub portion and a seat realized in the other thereof.

10. The filtering pulley according to claim 1, wherein said pair of second elements are projections integral with said crown.

11. The filtering pulley according to claim 1, wherein said at least one elastic group is circumferentially sliding inside a space formed between said first elements and/or said second elements.
